(19) United States
(12) Patent Application Publication
(10) Pub. No.: US 2025/0328639 A1
(43) Pub. Date: Oct. 23, 2025

(54) IMAGE PROCESSING DEVICE CAPABLE OF RECOVERING STORED DATA AND NON-TRANSITORY COMPUTER-READABLE STORAGE MEDIUM WITH BACKUP PROGRAM STORED THEREIN

(71) Applicant: KYOCERA Document Solutions Inc., Osaka (JP)

(72) Inventors: Wataru KAKENO, Osaka (JP); Koji SASADAI, Osaka (JP); Reo FURUSHO, Osaka (JP); Jin DAICHO, Osaka (JP)

(73) Assignee: KYOCERA Document Solutions Inc., Osaka (JP)

(21) Appl. No.: 19/185,031

(22) Filed: Apr. 21, 2025

(30) Foreign Application Priority Data
Apr. 23, 2024 (JP) 2024-070074

(51) Int. Cl. G06F 21/55; G06F 11/14

(52) U.S. Cl. CPC G06F 21/554; G06F 11/1469; G06F 2201/805; G06F 2221/034

(57) ABSTRACT

An image processing device includes a processor and a storage device. The processor includes a first controller disposed in a secure area, a second controller disposed in a non-secure area, and an abnormality detector that detects an abnormality in behavior of the processor. The storage device includes: a first region to which the first controller is accessible and in which security is ensured; and a second region to which both the first and second controllers are accessible and in which security is insecure. The first controller allows various data to be stored in the first region of the storage device. The second controller allows the various data to be stored in the second region of the storage device.

10 When the abnormality detector detects an abnormality, the first controller uses the various data stored in the first region to recover the data having been stored in the second region.

### INCORPORATION BY REFERENCE

This application claims priority to Japanese Patent Application No. 2024-070074 filed on Apr. 23, 2024, the entire contents of which are incorporated by reference herein.

### BACKGROUND

The present disclosure relates to image processing devices and programs.

When a falsification of a program is detected upon startup of an image processing device, generally, the operation of each program is stopped in order to prevent malicious manipulation and an error code or the like is displayed on a display device in order to notify the user that the program has been falsified.

Then, it is necessary to rewrite the falsified program to a normal program. Furthermore, the falsification of the program may cause even various kinds of setting data (network settings, facsimile settings, address book settings, and so on) to be falsified into malicious contents. Therefore, it also becomes necessary for the user to make the reconfiguration, initialization or other recovery operations of the various kinds of setting data, which involves significant time for recovery.

For example, there is proposed a technique that includes: a backup making means that makes, based on setting data, a backup of the setting data; a determination means that determines whether a falsification of a program has been detected; an update means that updates, upon detection of a falsification of the program by the determination means, the program and recovers the setting data using the backup of the setting data as new setting data, thus restoring the setting data to the same setting data as before the program is falsified.

### SUMMARY

A technique improved over the aforementioned technique is proposed as one aspect of the present disclosure.

An image processing device according to an aspect of the present disclosure includes a processor and a storage device. The processor is a processor including a first controller disposed in a secure area and a second controller disposed in a non-secure area and further includes an abnormality detector that detects an abnormality in behavior of the processor. The storage device includes: a first region to which the first controller is accessible and in which security is ensured; and a second region to which both the first controller and the second controller are accessible and in which security is insecure. The first controller allows various data to be stored in the first region of the storage device. The second controller allows the various data to be stored in the second region of the storage device. When the abnormality detector detects an abnormality, the first controller uses the various data stored in the first region of the storage device to do data recovery of the data having been stored in the second region of the storage device.

A non-transitory computer-readable recording medium according to another aspect of the present disclosure stores a backup program. The backup program allows a processor included in an image processing device and having a secure area where security is ensured and a non-secure area to operate as an abnormality detector that detects an abnormality in behavior of the processor. The backup program further allows the processor to operate, in the image processing device including a storage device having a first region where security is ensured and a second region where security is insecure, to allow various data to be stored in both the first region and the second region of the storage device and use, when the abnormality detector detects the abnormality in behavior of the processor, the various data stored in the first region of the storage device to do data recovery of the data having been stored in the second region of the storage device.

### BRIEF DESCRIPTION OF THE DRAWINGS

FIG. 1 is a diagram showing an electrical configuration of an image processing device.

FIG. 2 is a diagram for illustrating a control device and a storage device in detail.

FIG. 3 is a flowchart illustrating the flow of data recovery processing (data backup) in the image processing device.

FIG. 4 is a flowchart showing the flow of data recovery in the image processing device.

### DETAILED DESCRIPTION

Hereinafter, a description will be given of an image processing device, a non-transitory computer-readable storage medium with a backup program stored therein, and a data recovery method, each according to an embodiment of the present disclosure, with reference to the drawings. An image processing device according to this embodiment is an image forming apparatus, such as a printer or a copier, or a multifunction peripheral having multiple functions including, in addition to a print function and a copy function, a facsimile function, a scan function, and so on.

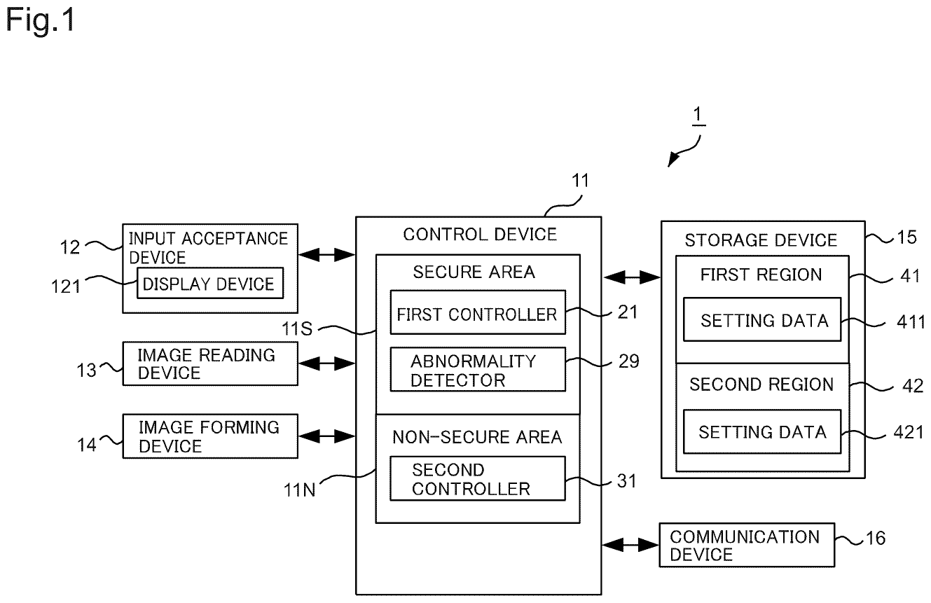

FIG. 1 is a diagram showing an electrical configuration of an image processing device 1 according to an embodiment of the present disclosure. The image processing device 1 includes a control device 11 (a processor), an input acceptance device 12, an image reading device 13, an image forming device 14, a storage device 15, a communication device 16, and so on.

The input acceptance device 12 includes hard keys, such as a decision key for giving a definite instruction for various operations and settings and a start key, and a display device 121. The input acceptance device 12 accepts, based on user's operations on these keys, inputs of various types of corresponding instructions. The display device 121 includes, for example, an LCD and displays an operation screen, a message, and so on. The display device 121 may include a touch panel and may be formed integrally with the touch panel.

The image reading device 13 includes, for example, a scanner, reads an image of an original document, and acquires image data representing the image. The image forming device 14 prints, on a sheet, image data acquired by the image reading device 13, image data received by the communication device 16 from an external device or other image data.

The storage device 15 is a large-capacity storage device that is constituted by, for example, an HDD or an SSD and stores image data, various kinds of programs, data tables, and so on. The storage device 15 includes: a first region 41 in which security is ensured; and a second region 42 in which security is insecure.

The communication device 16 is composed of a communication module or the like and transfers various data to and from external devices, such as a server, via a network.

The control device 11 is composed of a processor, a RAM (random access memory), a ROM, and so on. The processor is, for example, a CPU (central processing unit), an MPU (micro processing unit) or an ASIC (application specific integrated circuit).

Furthermore, the control device 11 is, for example, like a technique represented by TrustZone (registered trademark) manufactured by Arm Limited, a device that is a single piece of hardware, but is separated, in the hardware level, into a secure area 11A and a non-secure area 11N. Applications operating in the non-secure area are specified to be inaccessible directly to data in the secure area. For this reason, even if malware falsifies data in the non-secure area, the applications operating in the non-secure area cannot access directly to the data in the secure area and, therefore, the original data in the non-secure area can be recovered using the data in the secure area.

The control device 11 includes, in the secure area 11S, a first controller 21 and an abnormality detector 29. The control device 11 includes, in the non-secure area 11N, a second controller 31. Each of the first controller 21, the second controller 31, and the abnormality detector 29 is constituted by, for example, an OS and an application. The first controller 21 executes an application in the secure area, the second controller 31 executes an application in the non-secure area, and, thus, they realize respective functions of the image processing device 1. The first controller 21 and the second controller 31 execute data recovery processing in accordance with the backup program stored in the RAM or ROM built in the control device 11.

The abnormality detector 29 detects a behavior different from predetermined normal behaviors (such as execution of an application not present in a whitelist, execution of a privileged command not supposed to be normally used, an abnormal access to the secure area 11S, or an abnormal consumption of a hardware resource), which may be caused by a falsification, a breach or so on of the control device 11 by malware or the like, as an abnormality in behavior of the processor. The whitelist is stored in the abnormality detector 29.

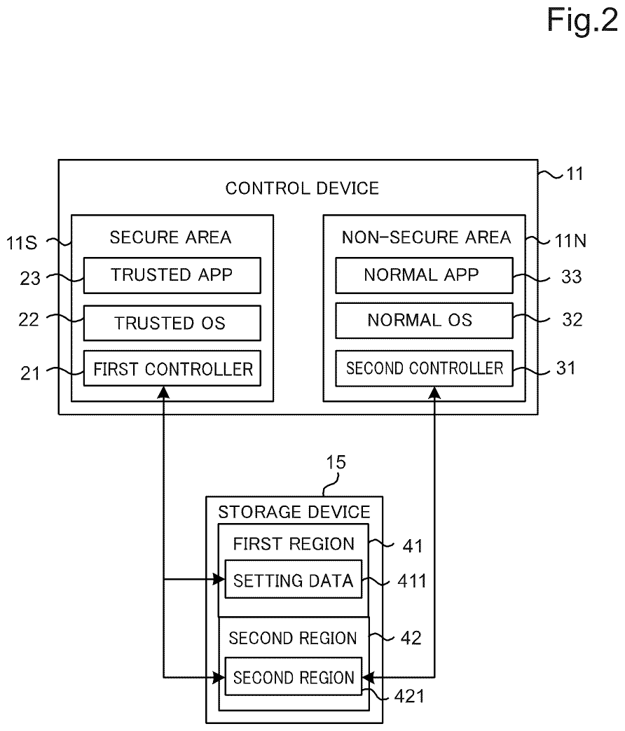

FIG. 2 is a diagram for illustrating the control device 11 and the storage device 15 in detail. In the secure area 11S of the control device 11, the first controller 21 executes a trusted application 23 when running a trusted OS 22, thus realizing a function provided by the trusted application 23. In the non-secure area 11N of the control device 11, the second controller 31 executes a normal OS 32 and a normal application 33, thus realizing a function provided by the normal application 33.

The second controller 31 in the non-secure area 11N is accessible only to the data in the second region 42 of the storage device 15. In other words, the second controller 31 is inaccessible to the first region 41 of the storage device 15. The first controller 21 in the secure area 11S is accessible to both the first region 41 and the second region 42 of the storage device 15. Since the storage device 15 is separated into regions in this manner, even if any program or data in the non-secure area 11N is falsified, a breach of the first region 41 can be prevented.

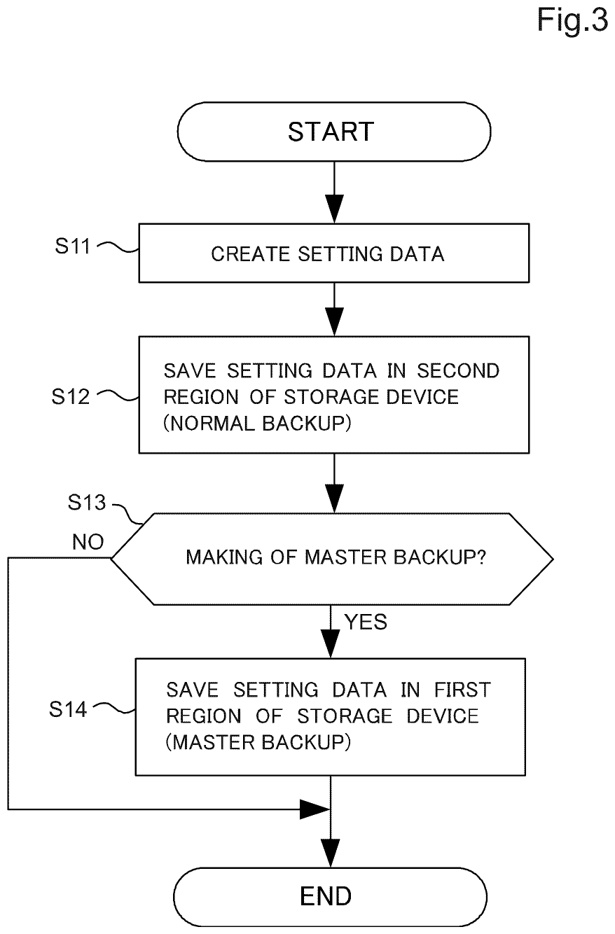

FIG. 3 is a flowchart illustrating the flow of data recovery processing (data backup) in the image processing device 1. When the user sets up a function of the image processing device 1 (upon setup of the device), the second controller 31 creates setting data for the function (S11) and saves the setting data in the second region 42 of the storage device 15, i.e., does a so-called normal backup (S12, SETTING DATA 421 in FIG. 2).

Data to be backed up includes, not only the setting data for the image processing device 1, but also data on an address book, setting data for the network, and so on. The normal backup of the setting data by the second controller 31 may be done every time the function settings are changed or may be done at the time specified by the user.

Subsequently, when the user inputs to the input acceptance device 12 an instruction to make a master backup (YES in S13), the first controller 21 saves the setting data in the first region 41 of the storage device 15, i.e., does a so-called master backup (S14, SETTING DATA 411 in FIG. 2). In the manner as thus far described, the setting data is subjected to both the normal backup and the master backup and thus stored in both the first region and the second region.

The master backup by the first controller 21 may be done at the same time as the normal backup. The setting data 411 saved by the master backup is stored in the region inaccessible by the second controller 31 of the non-secure area 11N. Therefore, even if the non-secure area of the control device 11 is breached by malware or the like, the setting data 411 is prevented from being falsified.

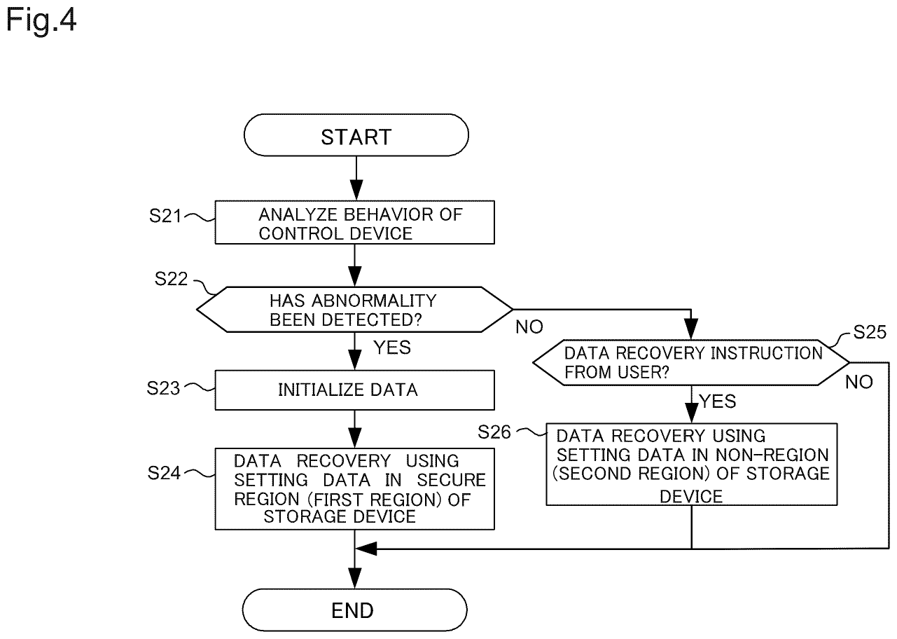

FIG. 4 is a flowchart showing the flow of data recovery. The abnormality detector 29 analyzes the behavior of the control device 11 (S21). When the abnormality detector 29 detects an abnormality in behavior (YES in S22), the first controller 21 initializes the setting data 421 stored in the second region 42 (S23).

Then, the first controller 21 writes the setting data 411 stored in the first region 41 into the second region 42 (S24). In other words, the first controller 21 uses the setting data 411 stored in the first region 41 to do data recovery (S24). Without the use of the setting data 421 stored in the second region 42 that may have been breached, but with the use of the setting data 411 stored in the first region 41 where security is ensured, the first controller 21 does data recovery safely.

Furthermore, when the abnormality detector 29 has not detected an abnormality (NO in S22) but an instruction to do data recovery is input to the input acceptance device 12 by a user's operation (YES in S25), the second controller 31 uses the setting data 421 stored in the second region 42 to do data recovery (S26).

As thus far described, the storage device 15 is separated into the first region 41 where security is ensured and the second region 42 where security is insecure, a master backup is saved in the first region 41, and a normal backup is saved in the second region 42. Therefore, in the event of a breach of the control device 11, data recovery can be safely done, using not the data in the second region 42 which may have been breached, but the setting data stored in the first region 41.

In a data recovery method not according to this embodiment, setting data is held on an HDD (hard disk drive) and the setting data itself may have been breached. Therefore, in recovering the setting data, falsified setting data may be used, which presents a problem of failure to do data recovery normally. Unlike the above, in this embodiment, setting data saved in a condition where the security is ensured is used to do data recovery. Specifically, in this embodiment, the processor is separated into the secure area and the non-secure area, the storage device is also separated into the first region to which only the first controller disposed in the secure area is accessible and the second region to which both the first controller and the second controller are accessible, and setting data is saved in both the first region and the second region. In events like this where the processor has been breached by malware or the like, the data having been stored in the second region can be safely recovered using the setting data stored in the first region.

While the present disclosure has been described in detail with reference to the embodiments thereof, it would be apparent to those skilled in the art that the various changes and modifications may be made therein within the scope defined by the appended claims.

What is claimed is:

1. An image processing device comprising:
a processor comprising a first controller disposed in a secure area and a second controller disposed in a non-secure area, the processor further comprising an abnormality detector that detects an abnormality in behavior of the processor; and
a storage device including (a) a first region to which the first controller is accessible and in which security is ensured and (b) a second region to which both the first controller and the second controller are accessible and in which security is insecure,
wherein the first controller allows various data to be stored in the first region of the storage device,
the second controller allows the various data to be stored in the second region of the storage device, and
when the abnormality detector detects an abnormality, the first controller uses the various data stored in the first region of the storage device to do data recovery of the data having been stored in the second region.

2. The image processing device according to claim 1,
further comprising an input acceptance device that accepts an instruction from a user,
wherein in doing the data recovery, not when the abnormality detector detects an abnormality, but in accordance with an instruction to do data recovery accepted by the input acceptance device, the first controller uses the various data stored in the second region of the storage device to do data recovery of the data having been stored in the second region.

3. The image processing device according to claim 1, wherein the abnormality detector detects execution of an application not present in a whitelist, execution of a privileged command not supposed to be normally used, an abnormal access to the secure area, or an abnormal consumption of a hardware resource as the abnormality in behavior.

4. A non-transitory computer-readable storage medium with a backup program stored therein,
the backup program allowing a processor included in an image processing device, the processor having a secure area where security is ensured and a non-secure area, to operate as an abnormality detector that detects an abnormality in behavior of the processor,
the backup program further allowing the processor to operate, in the image processing device comprising a storage device including a first region where security is ensured and a second region where security is insecure, to allow various data to be stored in both the first region and the second region of the storage device and use, when the abnormality detector detects the abnormality in behavior of the processor, the various data stored in the first region of the storage device to do data recovery of the data having been stored in the second region of the storage device.
